(19) United States
(12) Patent Application Publication
(10) Pub. No.: US 2026/0113412 A1
(43) Pub. Date: Apr. 23, 2026

(54) INKJET PRINTING APPARATUS, INKJET PRINTING METHOD, AND STORAGE MEDIUM

(71) Applicant: Konica Minolta, Inc., Tokyo (JP)

(72) Inventor: Satoru SHIRASAKA, Tokyo (JP)

(21) Appl. No.: 19/356,498

(22) Filed: Oct. 13, 2025

(30) Foreign Application Priority Data
Oct. 17, 2024 (JP) 2024-181907

(51) Int. Cl. H04N 1/60

(52) U.S. Cl. CPC H04N 1/6044; H04N 1/6036

(57) ABSTRACT

An inkjet printing apparatus includes a printer that produces a printed material and an in-line colorimeter that detects a color measurement chart on, among the printed material, a printed material for color measurement with the color measurement chart printed. The color measurement chart includes a color measurement patch and a position patch. The in-line colorimeter reads information other than a color measurement value from the position patch while waiting for color stabilization of the color measurement chart.

### CROSS-REFERENCE TO RELATED APPLICATION

The entire disclosure of Japanese Patent Application No. 2024-181907, filed on Oct. 17, 2024, including description, claims, drawings and abstract is incorporated herein by reference.

### BACKGROUND OF THE INVENTION

### Technical Field

The present disclosure relates to an inkjet printing apparatus, an inkjet printing method, and a storage medium.

### Description of Related Art

Japanese Unexamined Patent Publication No. 2012-66591 describes an inkjet printing apparatus having a function of a color measurement section. In such an apparatus, for example, detection of an inclination of a sheet is performed before color measurement.

### SUMMARY OF THE INVENTION

In a case of executing color measurement on a printed material in an apparatus as described above, it is necessary to wait to execute color measurement until ink dries and a color value(s) stabilizes. Therefore, it takes a long time to obtain color measurement data after a printed material as a target for color measurement is printed, which leaves room for improvement in productivity.

The present disclosure has been made in view of the above circumstances. An object of the present disclosure is to provide an inkjet printing apparatus, an inkjet printing method and a storage medium that are high in productivity.

The above object according to the present disclosure is solved by the following means.

To achieve at least one of the abovementioned objects, according to an aspect of the present disclosure, an inkjet printing apparatus reflecting one aspect of the present disclosure includes:
a printer that produces a printed material; and
an in-line colorimeter that detects a color measurement chart on, among the printed material, a printed material for color measurement with the color measurement chart printed,
wherein the color measurement chart includes a color measurement patch and a position patch, and
wherein the in-line colorimeter reads information other than a color measurement value from the position patch while waiting for color stabilization of the color measurement chart.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a schematic configuration diagram of an embodiment of an inkjet printing apparatus;

FIG. 2 is a block diagram illustrating a functional configuration of the embodiment of the inkjet printing apparatus;

FIG. 3 is a configuration diagram illustrating an example of an in-line color measurement section;

FIG. 4 illustrates an example of a color measurement chart;

FIG. 5 illustrates another example of the color measurement chart; and

FIG. 6 is a flowchart illustrating an example of a color measurement process.

### DETAILED DESCRIPTION

The following description will explain one or more embodiments of the present disclosure with reference to the drawings. The effects and features of the embodiments of the present disclosure are understood from the following detailed description and the drawings. The following detailed description and the drawings are provided for illustration only and do not limit the scope of the present disclosure.

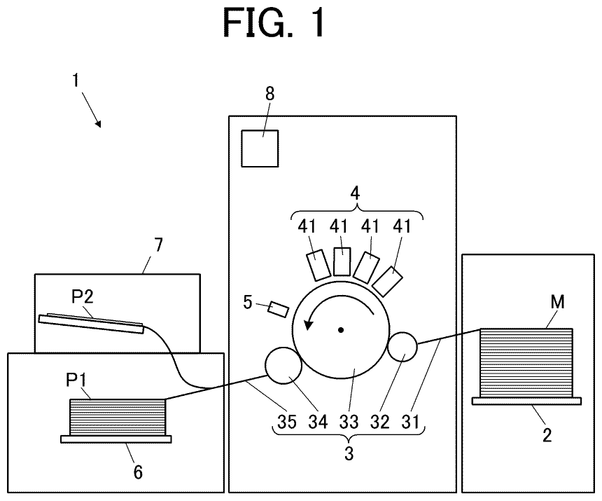

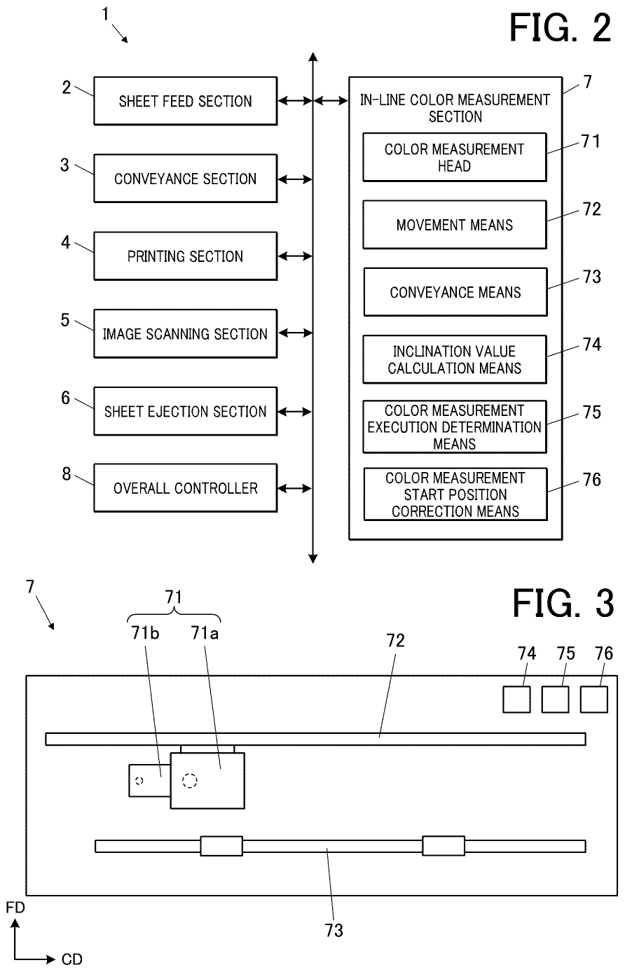

FIG. 1 is a schematic configuration diagram of an embodiment of an inkjet printing apparatus 1. FIG. 2 is a block diagram showing a functional configuration of the embodiment of the inkjet printing apparatus 1.

As shown in FIG. 1 and FIG. 2, the inkjet printing apparatus 1 of the present disclosure may include a sheet feed section 2, a conveyance section 3, a printing section 4 (printer), an image scanning section 5, a sheet ejection section 6 (sheet ejector), an in-line color measurement section 7 (in-line colorimeter), and an overall controller 8 (processor).

The sheet feed section 2 stores recording media M. The sheet feed section 2 includes, for example, a tray. Examples of the recording media M include a printing sheet, a textile, and a sheet-like resin. Examples of the printing sheet include plain paper and coated paper.

As illustrated in FIG. 1, the conveyance section 3 includes, for example, a feeder board 31, a first delivery drum 32, a conveyance drum 33, a second delivery drum 34, and a carry-out section 35.

The feeder board 31 conveys a recording medium M from the sheet feed section 2 to the first delivery drum 32. The first delivery drum 32 holds and picks up one end of the recording medium M conveyed by the feeder board 31, and delivers the recording medium M to the conveyance drum 33.

The conveyance drum 33 has, for example, a columnar shape. The circumferential surface of the conveyance drum 33 is a conveyance surface that attracts and holds the recording medium M. The conveyance drum 33 rotates in one direction about the central axis as the rotation axis in a state of holding the recording medium M on the conveyance surface. Thus, the conveyance drum 33 conveys the recording medium M, which is attracted to and held by the conveyance surface, along the conveyance surface.

The printing section 4 may include, for example, one or a plurality of head units 41. Each head unit 41 includes one or a plurality of inkjet heads. The head unit 41 may have an ink ejection face at a position facing the conveyance surface of the conveyance drum 33. The head unit 41 forms an image by ejecting ink onto the recording medium M held by the conveyance drum 33 at an appropriate timing in accordance with the rotation of the conveyance drum 33, thereby producing a printed material. The ink is not particularly limited, but, for example, an ultraviolet curable ink is used.

In the inkjet printing apparatus 1 illustrated in FIG. 1, four head units 41 are arranged side by side at predetermined intervals in order from the upstream in the rotation direction of the conveyance drum 33. The four head units 41 correspond to inks of four colors, for example, yellow, magenta, cyan, and black, respectively.

The printing section 4 may include an ultraviolet irradiation section on the downstream of the head units 41 in the conveyance direction. In a case where the ink is ultraviolet curable ink, the ink on the recording medium M can be cured by irradiation with ultraviolet rays by the ultraviolet irradiation section.

The printing section 4 performs print jobs such as a normal job and a color measurement job by the inkjet method. The normal job is a print job for producing a normal printed material P1 that is not the target for color measurement. The color measurement job is a print job for producing a printed material P2 for color measurement with a color measurement chart 200 printed.

The image scanning section 5 irradiates a printed material with light from a light source and reads the reflected image in order to read information on presence or absence of a defect in the printed material, the position of a defective nozzle, and the like. The image scanning section 5 is composed of, for example, an in-line sensor in which detection elements are arranged along a direction (width direction) perpendicular to the conveyance direction of a printed material. Data of the image read by the image scanning section 5 is sent to, for example, the overall controller 8.

The second delivery drum 34 holds and picks up one end of the printed material conveyed by the conveyance drum 33, and delivers the printed material to the carry-out section 35. The carry-out section 35 is a carry-out route for the printed material, and conveys the printed material to the sheet ejection section 6 or the in-line color measurement section 7. To be specific, the carry-out section 35 conveys the normal printed material P1 produced by the normal job to the sheet ejection section 6, and conveys the printed material P2 for color measurement produced by the color measurement job to the in-line color measurement section 7. The carry-out section 35 is composed of, for example, a belt, a roller, and the like. The conveyance route in the carry-out section 35 may branch in the middle as shown in FIG. 1. The sheet ejection section 6 includes, for example, a tray.

As shown in FIG. 1, it is preferable that the inkjet printing apparatus 1 includes the sheet ejection section 6 to which the printed material is ejected, separately from the in-line color measurement section 7. Thus, the normal printed material P1 can be ejected to the sheet ejection section 6 even during the waiting for color stabilization or during color measurement by the in-line color measurement section 7. Therefore, in a case where the next print job does not require color measurement data, the next print job can be executed even during the waiting for color stabilization or during color measurement. Thus, productivity is improved.

The in-line color measurement section 7 is a device that detects the color measurement chart 200, and is arranged in-line in the inkjet printing apparatus 1. FIG. 3 is a configuration diagram illustrating an example of the in-line color measurement section 7. As illustrated in FIG. 3, the in-line color measurement section 7 includes, for example, a color measurement head 71, a movement means 72, and a conveyance means 73. The color measurement head 71 may include a color measurement sensor 71a and a position sensor 71b. The color measurement sensor 71a optically detects color measurement patches 201 and executes color measurement thereon. Color measurement is measurement of color information, for example, measurement of color values such as L*a*b* values. As the color measurement sensor 71a, for example, a spectral colorimeter that executes color measurement by dispersing reflected light from the color measurement patches 201 can be used. The position sensor 71b detects position patches 202. Specifically, the position sensor 71b detects, with respect to each of the position patches 202, the distance from the base position of the position sensor 71b. For example, the position sensor 71b detects a distance Ta to a first position patch from the base position of the position sensor 71b. Further, the position sensor 71b detects a distance Tb to a second position patch from the base position of the position sensor 71b. The first position patch and the second position patch are the position patches 202 arranged in the FD direction. The first position patch is positioned on the front side (forward side) in the FD direction as compared to the second position patch. The position sensor 71b is adjacent to and mechanically attached to the color measurement sensor 71a, for example, and is movable together with the color measurement sensor 71a. The position sensor 71b is, for example, a single-wavelength reflective optical fiber sensor or a reflective color sensor. The movement means 72 reciprocates the color measurement head 71 in the cross direction (CD direction). The conveyance means 73 conveys the recording medium M in the feed direction (FD direction) perpendicular to the CD direction.

The in-line color measurement section 7 may include an inclination value calculation means 74, a color measurement execution determination means 75, and a color measurement start position correction means 76. The functions of the inclination value calculation means 74, the color measurement execution determination means 75, and the color measurement start position correction means 76 are performed by a computer (processor) including a central processing unit (CPU), for example. The functions of the inclination value calculation means 74, the color measurement execution determination means 75, and the color measurement start position correction means 76 may be performed by one computer or may be performed by different computers. The functions of the inclination value calculation means 74, the color measurement execution determination means 75, and the color measurement start position correction means 76 may be performed not by a computer included in the in-line color measurement section 7 but by the overall controller 8 described later.

The inclination value calculation means 74 calculates the inclination value of the color measurement chart 200 on the basis of the distance from the base position of the position sensor 71b to each of the position patches 202. For example, the inclination value calculation means 74 calculates the inclination value (Ta/Tb) of the color measurement chart 200 on the basis of the distance Ta and the distance Tb. If the color measurement chart 200 is not inclined, the inclination value (Ta/Tb) is 1. If the color measurement chart 200 is inclined clockwise, the inclination value (Ta/Tb) is more than 1. If the color measurement chart 200 is inclined counterclockwise, the inclination value (Ta/Tb) is less than 1. The inclination of the color measurement chart 200 may be caused by a shift during printing or a shift during conveyance.

The color measurement execution determination means 75 determines that color measurement is impossible when the inclination value of the color measurement chart 200 is not within a predetermined range. If the color measurement execution determination means 75 determines that color measurement is impossible, the in-line color measurement section 7 stops waiting for color stabilization of the color measurement chart 200.

The color measurement start position correction means 76 corrects the color measurement start position on the basis of the inclination value of the color measurement chart 200. The color measurement start position is corrected with, for example, three patterns of the upper side, the center, and the lower side. The upper side is a position closer to the front in the FD direction. The center is a position at the center in the FD direction. The lower side is a position closer to the rear in the FD direction. For example, if the color measurement chart 200 is inclined counterclockwise by a predetermined threshold value or more, the color measurement start position is corrected to the upper side. For example, if the inclination value of the color measurement chart 200 is less than the predetermined threshold value, the color measurement start position is corrected to the center. For example, if the color measurement chart 200 is inclined clockwise by the predetermined threshold value or more, the color measurement start position is corrected to the lower side.

The overall controller 8 controls operation of the other functional configuration in accordance with print image data, print setting, and the like. The overall controller 8 is a computer and includes, for example, a central processing unit (CPU), a random access memory (RAM), and a read only memory (ROM). The CPU executes various control programs to drive and control the inkjet printing apparatus 1, and performs various calculations. The RAM provides a working memory space for the CPU and stores temporary data. The RAM may include a nonvolatile memory. The ROM stores various control programs executed by the CPU and setting data. Instead of the ROM, a rewritable nonvolatile memory such as a flash memory may be used.

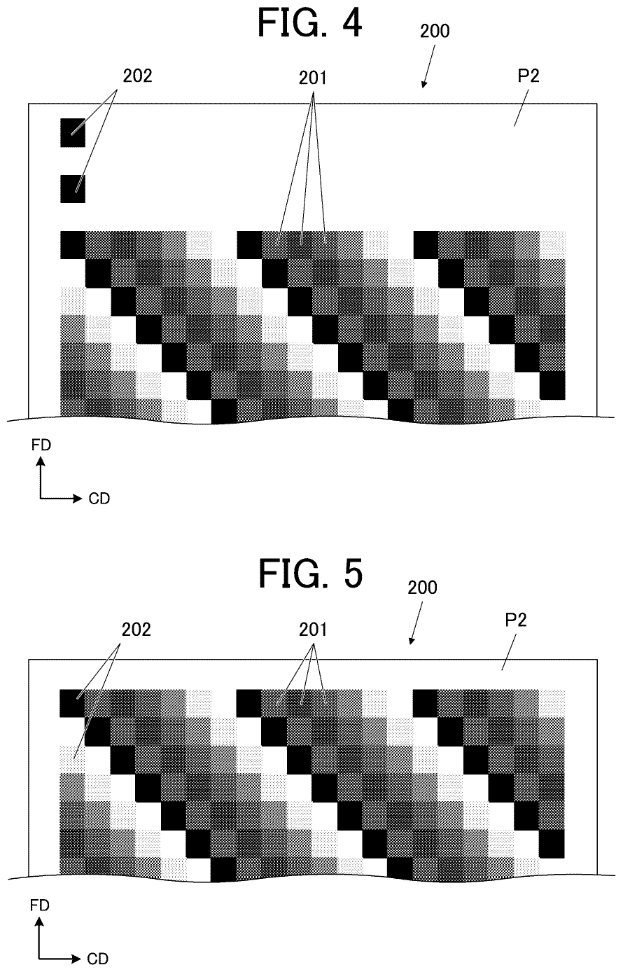

FIG. 4 and FIG. 5 are diagrams illustrating examples of the color measurement chart 200. As shown in FIG. 4 and FIG. 5, the color measurement chart 200 may include a plurality of color measurement patches 201 and a plurality of position patches 202. The plurality of color measurement patches 201 may form a plurality of columns arranged in the CD direction and a plurality of rows arranged in the FD direction. The foremost (most front side) row among the plurality of rows is the first row. The front side is the front side in the conveyance direction (FD direction) of the printed material P2 for color measurement. The color measurement patches 201 may have different color values.

As shown in FIG. 4, the position patches 202 may be positioned in front of the color measurement patches 201 in the conveyance direction of the printed material P2 for color measurement. The position patches 202 may be positioned next to each other in a state of being separated from each other in the CD direction. In the color measurement chart 200 illustrated in FIG. 4, the position patches 202 do not double as the color measurement patches 201. Since the position patches 202 do not double as the color measurement patches 201, it is easy to control reading of the position patches 202.

In contrast, as shown in FIG. 5, the position patches 202 may double as the color measurement patches 201. In this case, the position patches 202 may constitute a plurality of columns arranged in the CD direction and a plurality of rows arranged in the FD direction together with the color measurement patches 201, for example. Since the position patches 202 double as the color measurement patches 201, the number of independent position patches 202 can be reduced or the position patches 202 can be eliminated, and therefore the number of color measurement patches 201 in one color measurement chart 200 can be easily increased.

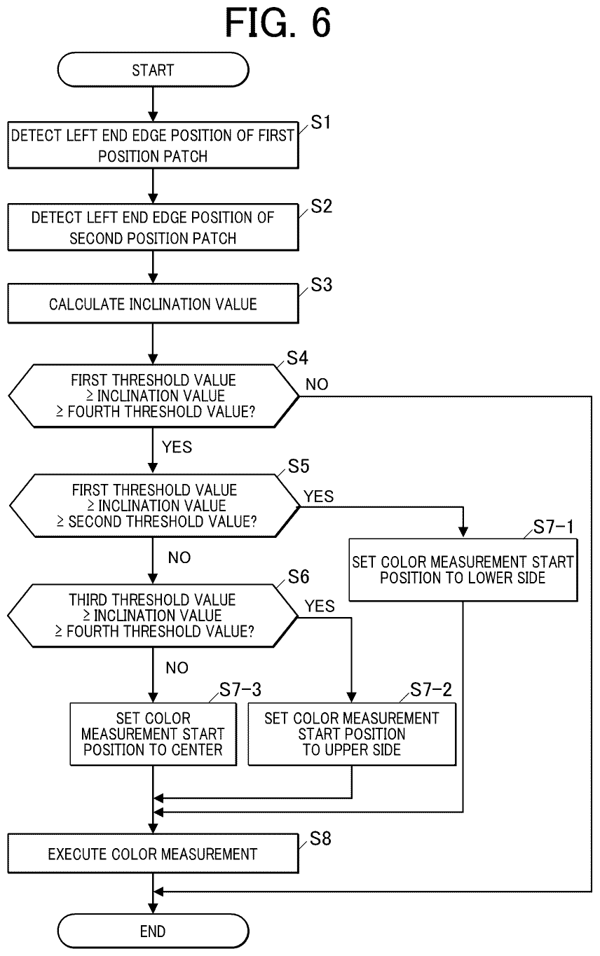

FIG. 6 is a flowchart illustrating an example of a color measurement flow. In the flowchart, the inkjet printing apparatus 1 according to the present disclosure executes Step S1 to Step S7 (Step S7-1, Step S7-2, or Step S7-3) while waiting for color stabilization of the color measurement chart 200. The “waiting for color stabilization” is to wait until the color values of the color measurement patches 201 become stable. In the color measurement patches 201 printed by the inkjet method, for example, the color values do not become stable until the ink dries, and therefore it is necessary to wait for color stabilization.

In Step S1, the position sensor 71b detects the left end edge position of the first position patch. The left end edge position is the position of the edge of a position patch 202 on the left side when facing the conveyance direction of the printed material P2 for color measurement. The distance Ta from the base position of the position sensor 71b to the first position patch is obtained from the left end edge position of the first position patch.

In Step S2, the position sensor 71b detects the left end edge position of the second position patch. The distance Tb from the base position of the position sensor 71b to the second position patch is obtained from the left end edge position of the second position patch.

In Step S3, the inclination value calculation means 74 calculates the inclination value of the color measurement chart 200 on the basis of the distance from the base position of the position sensor 71b to each of the position patches 202. Specifically, the inclination value calculation means 74 calculates the inclination value (Ta/Tb) of the color measurement chart 200 on the basis of the distance Ta and the distance Tb.

In Step S4, the color measurement execution determination means 75 determines whether color measurement can be executed. Specifically, the color measurement execution determination means 75 determines that color measurement is possible if the inclination value of the color measurement chart 200 is within a predetermined range, and determines that color measurement is impossible if the inclination value of the color measurement chart 200 is not (i.e., is outside) the predetermined range. For example, a first threshold value that is the upper limit and a fourth threshold value that is the lower limit of the inclination value with which color measurement can be executed are set from the size (dimensions) of one row of color measurement patches 201 in the FD direction and the CD direction. The first threshold value can be appropriately determined on the basis of the size of the color measurement chart 200 or the like, and is, for example, 1.3. The fourth threshold value can be appropriately determined on the basis of the size of the color measurement chart 200 or the like, and is, for example, 0.7. The color measurement execution determination means 75 determines that color measurement is possible if the inclination value is equal to or less than the first threshold value and equal to or more than the fourth threshold value, and determines that color measurement is impossible if the inclination value is more than the first threshold value or less than the fourth threshold value. If the color measurement execution determination means 75 determines that color measurement is possible, the flow proceeds to Step S5. If the color measurement execution determination means 75 determines that color measurement is impossible, the waiting for color stabilization of the color measurement patterns 200 is stopped, and the color measurement flow ends without color measurement.

In Step S5 to Step S7 (Step S7-1, Step S7-2, or Step S7-3), the color measurement start position correction means 76 corrects the color measurement start position on the basis of the inclination value of the color measurement chart 200 as described below.

In Step S5, the color measurement start position correction means 76 determines whether the inclination value is equal to or less than the first threshold value and equal to or more than a second threshold value. The second threshold value is, for example, less than the first threshold value and more than 1. The second threshold value can be appropriately determined on the basis of the size of the color measurement chart 200 or the like, and is, for example, 1.1. If the inclination value is equal to or less than the first threshold value and equal to or more than the second threshold value, the flow proceeds to Step S7-1. If the inclination value is not equal to or less than the first threshold value and equal to or more than the second threshold value, the flow proceeds to Step S6.

In Step S6, the color measurement start position correction means 76 determines whether the inclination value is equal to or less than a third threshold value and equal to or more than the fourth threshold value. The third threshold value is, for example, less than 1 and more than the fourth threshold value. The third threshold value can be appropriately determined on the basis of the size of the color measurement chart 200 or the like, and is, for example, 0.9. If the inclination value is equal to or less than the third threshold value and equal to or more than the fourth threshold value, the flow proceeds to Step S7-2. If the inclination value is not equal to or less than the third threshold value and equal to or more than the fourth threshold value, that is, if the inclination value is less than the second threshold value and more than the third threshold value, the flow proceeds to Step S7-3.

In Step S7-1, the color measurement start position correction means 76 sets the color measurement start position to the upper side. In Step S7-2, the color measurement start position correction means 76 sets the color measurement start position to the center. In Step S7-3, the color measurement start position correction means 76 sets the color measurement start position to the lower side.

After Step S7-1, S7-2 or S7-3, in Step S8, color measurement is executed, and the color measurement sensor 71a measures color information on the color measurement patches 201. For example, first, the movement means 72 causes the color measurement head 71 to perform scanning in the CD direction from the set color measurement start position. At the time, the color measurement sensor 71a executes color measurement on the color measurement patches 201 of the first row. When the color measurement on the first row is completed, the conveyance means 73 conveys the printed material P2 for color measurement by one row in the FD direction. Next, the movement means 72 causes the color measurement head 71 to perform scanning in the CD direction. At the time, the color measurement sensor 71a executes color measurement on the color measurement patches 201 of the second row. When the color measurement on the second row is completed, the conveyance means 73 again conveys the printed material P2 for color measurement in the FD direction by one row. When these operations are repeated and color measurement on all the color measurement patches 201 is completed, the color measurement flow ends. The scanning direction of the color measurement head 71 in the CD direction is, for example, from left to right at odd-numbered rows and from right to left at even-numbered rows. The color measurement start position is the lower side at even-numbered rows if it is the upper side at odd-numbered rows, whereas the color measurement start position is the upper side at even-numbered rows if it is the lower side at odd-numbered rows.

As in the above-described example, in the inkjet printing apparatus 1 according to the present disclosure, the in-line color measurement section 7 reads information other than the color measurement values from the position patches 202 while waiting for color stabilization of the color measurement chart 200. The information other than the color measurement values is, for example, the positions of the position patches 202. To be specific, the information other than the color measurement values may be the distance from the base position of the position sensor 71b to a position patch 202. The information other than the color measurement values may be the distances from the base position of the position sensor 71b to position patches 202. The in-line color measurement section 7 reads the information other than the color measurement values from the position patch(es) 202 while waiting for color stabilization of the color measurement chart 200, and thus can start color measurement immediately after waiting for color stabilization. Thus, productivity is improved.

The inkjet printing method of the present disclosure includes a printing step of producing a printed material(s), and a color measurement step of detecting the color measurement chart 200 on, among the printed material(s), the printed material P2 for color measurement with the color measurement chart 200 printed. The color measurement chart 200 includes the color measurement patches 201 and the position patches 202 as described above. As described above, the inkjet printing method of the present disclosure reads, in the color measurement step, the information other than the color measurement values from the position patches 202 while waiting for color stabilization of the color measurement chart 200.

A program according to the present disclosure is a program that causes the computer included in the above-described inkjet printing apparatus 1 to function as a controller (processor). The computer functioning as the controller by the program causes the in-line color measurement section 7 to read the information other than the color measurement values from the position patches 202 while waiting for color stabilization of the color measurement chart 200.

The foregoing description and the drawings are merely illustrative of embodiments of the present disclosure and are not intended to limit the scope of the present disclosure. The scope of the present disclosure should be interpreted by terms of the appended claims.

What is claimed is:

1. An inkjet printing apparatus comprising:
a printer that produces a printed material; and
an in-line colorimeter that detects a color measurement chart on, among the printed material, a printed material for color measurement with the color measurement chart printed,
wherein the color measurement chart includes a color measurement patch and a position patch, and
wherein the in-line colorimeter reads information other than a color measurement value from the position patch while waiting for color stabilization of the color measurement chart.

2. The inkjet printing apparatus according to claim 1, comprising a sheet ejector that is provided separately from the in-line colorimeter and to which the printed material is ejected.

3. The inkjet printing apparatus according to claim 1,
wherein the in-line colorimeter includes a position sensor that reads a position of the position patch, and
wherein the information other than the color measurement value is a distance from a base position of the position sensor to the position patch.

4. The inkjet printing apparatus according to claim 3, wherein the information other than the color measurement value is the distance from the base position of the position sensor to each of position patches each being the position patch.

5. The inkjet printing apparatus according to claim 4, wherein an inclination value of the color measurement chart is calculated based on the distance from the base position of the position sensor to the each of the position patches.

6. The inkjet printing apparatus according to claim 5, wherein a color measurement start position is corrected based on the inclination value of the color measurement chart.

7. The inkjet printing apparatus according to claim 6, wherein in response to the inclination value of the color measurement chart being outside a predetermined range, determination is made that color measurement is impossible, and the waiting for color stabilization of the color measurement chart is stopped.

8. The inkjet printing apparatus according to claim 1, wherein the position patch does not double as the color measurement patch.

9. The inkjet printing apparatus according to claim 8, wherein the position patch is positioned on a front side in a conveyance direction of the printed material for color measurement as compared to the color measurement patch.

10. The inkjet printing apparatus according to claim 1, wherein the position patch doubles as the color measurement patch.

11. An inkjet printing method comprising:
producing a printed material; and
detecting a color measurement chart on, among the printed material, a printed material for color measurement with the color measurement chart printed,
wherein the color measurement chart includes a color measurement patch and a position patch, and
wherein the detecting includes reading information other than a color measurement value from the position patch while waiting for color stabilization of the color measurement chart.

12. A non-transitory computer-readable storage medium storing a program causing, of an inkjet printing apparatus including a printer that produces a printed material and an in-line colorimeter that detects a color measurement chart on, among the printed material, a printed material for color measurement with the color measurement chart printed, a computer to perform control,
wherein the color measurement chart includes a color measurement patch and a position patch, and
wherein the program causes the computer to cause the in-line colorimeter to read information other than a color measurement value from the position patch while waiting for color stabilization of the color measurement chart.
